(19) United States
(12) Patent Application Publication
(10) Pub. No.: US 2017/0175464 A1
(43) Pub. Date: Jun. 22, 2017

(54) DRILLING FLUID RECOVERY CHUTE

(71) Applicants: Jeff Cooke, Turner Valley (CA); Kari Pomerleau, Calgary (CA)

(72) Inventors: Jeff Cooke, Turner Valley (CA); Kari Pomerleau, Calgary (CA)

(21) Appl. No.: 15/379,218

(22) Filed: Dec. 14, 2016

Related U.S. Application Data
(60) Provisional application No. 62/268,858, filed on Dec. 17, 2015.

(51) Int. Cl. E21B 21/06; B01D 21/00; B01D 21/28

(52) U.S. Cl. CPC E21B 21/065; B01D 21/283; B01D 21/0012

(57) ABSTRACT

The invention relates to an apparatus for use with a shale shaker and more specifically to a drilling fluid recovery chute that is attached to and receives tailings from the discharge end of a shale shaker. The drilling fluid recovery chute removes drilling fluids from the waste tailings that are discharged from the shale shaker so that they can be reused or recycled. The invention also relates to a method for recovering drilling fluids from the tailings of a shale shaker.

### FIELD

This disclosure relates to an apparatus that is connected to a shale shaker and that is used to recover drilling fluids from the waste stream of a shale shaker.

### BACKGROUND

Drilling fluids are used to aid in the drilling of wellbores into the earth. The main functions of drilling fluids are to provide hydrostatic pressure to keep formation fluids from entering the wellbore, to lubricate the drill bit and to keep it cool and clean during drilling, and to convey drill cuttings out of the wellbore. Drilling fluids are often called drilling “muds” and are a mixture of various chemicals in a water or oil based solution. These fluids can be very expensive to make. For both environmental reasons and to reduce the costs, the loss of drilling fluids is minimized by stripping the fluid away from the solid drill cuttings for reuse, before the cuttings are disposed of. This may be done using a number of specialized machines and tanks.

The shale shaker is used to remove large solid cuttings from the drilling fluid exiting the borehole, and has played important role in oilfield solids control schemes for several decades. Shale shakers are also used in other industries, such as coal cleaning and mining, as the first phase of a solids control system. After returning to the surface of a wellbore, drilling fluid laden with cuttings flows directly to the shale shakers, where it begins to be processed. Shale shakers are, essentially, vibrating sieves that remove drill cuttings (commonly shale) from the drilling fluid.

Basic designs feature large screens that shake or vibrate the drill cuttings off of the screens, while fluid flows through the screens. Drilling fluid that passes through the screens is deposited into the mud tanks where other solids control equipment begin to remove the finer solids from it. The solids on the other hand are discharged out of the discharge port into a separate holding tank where they await further treatment or disposal.

Shale shakers generally consist of the following parts:
a) Hopper: commonly called the “base”, which serves as a platform for the shaker and a collection pan for the fluid that flows through the shaker screens;
b) Feeder: a pan that collects the drilling fluid to be applied to the screens. Most commonly used is a weir feeder, in which drilling fluid fills the feeder and then spills over a weir and onto the screening area of the shaker;
c) Screen Basket—also known as the “Bed”, holds the screens in place, transfers the shaking intensity of the machine to the drilling fluid and eliminates solids bypass to the hopper;
d) Basket Angling Mechanism: changes the angle of the screen basket to accommodate various flow rates of drilling fluids and to maximize the use of the shaker bed;
e) Vibrator: applies vibratory force and motion to the screen basket, which can be elliptical, circular or linear.

The components of a shale shaker are constantly exposed to extreme vibration, abrasive materials and overall harsh operating conditions. The screens in particular may wear over time and therefore they are commonly removably secured to the basket so that they can be repaired or replaced.

The challenge in designing any shale shaker is to maximize solids removal and drilling fluid recovery, while also maximizing the volume of drilling material (i.e., returned drilling fluid, cuttings and cavings) that is processed by the shaker. As the speed of conveyance of drilling material along the shaker is increased the amount of drilling fluid in the produced tailings solids also generally increases, and this loss of drilling fluid can be cost-prohibitive. Conversely, if the speed of the conveyance of drilling material along the shaker is decreased to improve fluid recovery, processing times are increased, which can also be cost-prohibitive. In practice, in order to achieve the processing times required, a large amount of drilling fluid is often lost in the waste tailings stream from a shale shaker, by being attached to drill cuttings, or by wicking along the screen. A need remains to increase the solids fraction of the waste stream from a drilling operation, thus minimizing the loss of drilling fluids trapped in the waste stream and making these drilling fluids available for reuse.

### BRIEF DESCRIPTION OF THE DRAWINGS

FIG. 1A is a side view of a shale shaker with an embodiment of the recovery chute attached thereto. FIG. 1B is a cross sectional view of the apparatus of FIG. 1A. FIG. 1C is an end view of the apparatus of FIG. 1A.

FIG. 2A (left) is a side view of an embodiment of the recovery chute with a vibrator motor attached, showing air inflow and drain connection ports. FIG. 2A (right) is a top view of the embodiment with a single screen mounted in the upper part of the chute.

FIG. 2B (left) is a side view of an embodiment of the recovery chute, showing air inflow and drain connection ports and two layers of screens. FIG. 2B (right) is a top view of the embodiment.

FIG. 3A (left) is a side view of an embodiment of the recovery chute showing air inflow and drain connection ports. FIG. 3A (right) is a top view of the embodiment.

FIG. 3B (left) is a side view of an embodiment of the recovery chute showing air inflow and drain connection ports. FIG. 3B (right) is a top view of the embodiment.

FIG. 3C (left) is a side view of an embodiment of the recovery chute, showing air inflow and drain connection ports. FIG. 3C (right) is a top view of the embodiment.

### DETAILED DESCRIPTION

Described herein is drilling fluid recovery chute 10 that is located downstream from a shale shaker 12, and that is designed to recover drilling fluid that discharged, either as free fluid or attached to drilling cuttings, as waste tailings from the discharge end of the shaker. The chute 10 generally comprises a chute support frame 14 which is configured at a receiving end 16 to receive tailings from the discharge end of the shale shaker 12, so that tailings from the shale shaker may be received by the chute 10. The chute support frame 14 holds a deck 18 that further comprises a screen assembly 20, through which drilling fluid can pass into a manifold 24 or collection tray 24 below. Larger particulates and remaining drilling fluid that do not pass through the screen assembly, are discharged off of the discharge end 26 of the chute.

The chute is inclined downwardly from horizontal proceeding from the receiving end 16 to the discharge end 26, to promote the conveyance by gravity of the particulates in the shaker tailings towards the discharge end of the chute. The chute may optionally comprise a vacuum system, and/or an airflow discharge and/or a vibration system; these optional components may function alone or in combination to enhance the recovery of the drilling fluid from the shaker tailings stream. Therefore the flow rate of the particulates along the chute is governed primarily by gravity, optionally in combination with vibratory force.

The average size of the particulates in the composition treated by the chute will be substantially larger than the average size of the particulates in the composition treated by the shale shaker and the solids/liquid ratio will also be higher. This is because a substantial amount of smaller particulates, and a substantial volume of drilling fluid, will have been removed from the drilling material by the shale shaker, leaving a composition that comprises less drilling fluid and larger particulates to be treated by the chute. The drilling fluid recovered from the chute described herein is expected to be cleaner than the drilling fluid which passes through the shaker screens, because a large quantity of the small particulates have been removed by the shaker screens and will therefore not be recovered from the chute.

### Chute Support Frame

Chute support frame 14 is configured at the receiving end 16 of the chute to receive tailings from the discharge end of the shale shaker 12, and at the discharge end 26 of the chute to deliver the solids and fluids discharged from the chute (the “chute tailings”) to a receptacle that receives these tailings. The width of the receiving end of the chute corresponds in a substantially 1:1 ratio with the width of the discharge end of the shaker, so that all or essentially all of the waste tailings from the shaker are received by the chute. Support frame 14 may be configured to attach to the discharge end of the shale shaker or a shale bin, or it may be a free standing unit that is configured to catch the tailings directly from the shale shaker, or from a shale bin.

Chute support frame 14 functionally connects the deck 18 to the shale shaker or shale bin, and in embodiments where the deck is vibrated, to isolate the vibratory force generated by the vibrating apparatus, from the shale shaker and from the surrounding environment.

In use, chute support frame 14, and/or deck 18 are preferably angled from horizontal, so that the receiving end is above the discharge end, and the shaker tailings are conveyed along chute 10 at least in part by gravity. In some embodiments the chute support frame and/or deck 18 are inclined in the range of about 10 to about 80 degrees from horizontal, preferably between about 25 to about 60 degrees from horizontal. Because a larger deviation from horizontal is used in the chute described herein, as compared to a shale shaker, particulate conveyance along the chute occurs primarily by gravity as opposed to vibration, meaning that conveyance is more energy-efficient.

The chute support frame may include an elevator apparatus, for example a hydraulic or ratchet system, which adjusts the tilt and/or angle of the chute support frame after it is connected to the shale shaker 12.

In some embodiments, chute support frame 14 includes a collection tray 22, which functions as a receptacle for the drilling fluid that passes through the screen assembly. The surface of the collection tray may be flat or angled or curved towards, for example, a centre point or line. One or more ports 32, for collection of the drilling fluid that passes through the screen assembly, may be located at the bottom of the collection tray, and may or may not be connected to a conveying vacuum.

Features of the chute support frame may be modified to optimize operation of the chute with the particular shale shaker with which it is used. For example, the length and angle of the chute support frame, its area and its flow path may depend upon the shaker tailings flow rate and the percentage and size of particulates in the tailings, among other factors.

### Deck

Deck 18 holds the screen assembly in place, and is mounted on the chute support frame 14, so that drilling fluid that flows through the screen assembly 20 is collected in the collection tray 22 or manifold 24 underneath. Accordingly, deck 18 includes means to support the screen assembly on the deck. The screen assembly 20 can be attached to the deck in a variety of ways, including but not limited to bolts and compression wedges, as known for attaching screens to shale shakers (see for e.g., U.S. Pat. No. 8,827,080 to Holton). Deck 18 may also comprise means for attachment to the chute support frame.

Tailings from the shale shaker are deposited on deck 18, near the receiving end of the chute 10. Deck 18 may include side edges that prevent the drilling fluid and particulates from spilling over the sides of the deck. Features of the deck may be modified, for example, the length and angle of the deck and the area of the deck that is comprised of the screen assembly, depending on the shaker tailings flow rate and the percentage and size of particulates in the tailings, among other factors. The deck 18 may include one or more elevator apparatus, for example a hydraulic or ratchet system, which adjusts the tilt and/or angle of the deck relative to the chute support frame.

In embodiments of the chute 10 comprising a vibrating apparatus, the deck 18 is mounted on members, for example helical springs or rubber mounts that will isolate the vibration of the deck from the chute support frame 14, which are supported on the chute support frame. The deck is vibrated by a vibrating apparatus 28 which is mounted on the deck and driven by a motor. In these embodiments means of firmly holding the screen assembly 20 in place during vibration of the deck are also incorporated into the deck.

The deck may be designed to flow the waste tailings stream along a straight path or it may be channeled to direct the tailings along an optimized path for processing. The deck or screen assembly may comprise ridges that temporarily slow the transit of the particulates along the chute by obstructing transit until a level of particulate is reached that pushes the particulates over the ridge.

### Screen Assembly

The fluid recovery chute comprises at least one screen assembly 20 mounted on the deck 18. The screen assembly separates drilling fluid, which passes through the screen assembly, from larger solids (with or without drilling fluid) which do not pass through. Separated drilling fluid is collected in the collection tray 22 or manifold 24 below the screen assembly, and may be further processed downstream (e.g., to remove smaller cuttings) before being reused. Larger solids and any drilling fluid associated therewith move down the deck and screen assembly, and off of the discharge end of the chute.

Screen assembly 20 may be any known screen or any combination of screen cloth, coarse mesh, perforated metal sheet or the like, with a frame that enables the screen assembly to be mounted on deck 18. Screen assembly 20 is arranged generally parallel to the long axis of the chute. A perforated metal sheet may be used to support a screen, or may be used without a screen. The perforated metal sheet has a series of openings (e.g., apertures, holes, perforations, slots, slits, etc.), that may have edges that are flush with the upper and lower surfaces of the sheet. In some embodiments the edges of the openings protrude in whole in in part above the upper surface of the sheet; in others they protrude in whole or in part below the lower surface of the sheet. The openings may or may not be of uniform size.

Any screen or perforated metal sheet may be used in the screen assembly 20. Contemplated for use herein are screens and perforated metal sheets that are known in the art and that are used in shale shakers, for example pre-tensioned screens or metal plates that are disposed in a rigid frame. However screens and perforated metal sheets that are designed and manufactured for use in the chute are contemplated as well. In preferred embodiments the screens or perforated metal sheets are flat or nearly flat.

The screen assembly 20 may be continuous, with one screen and/or perforated metal sheet covering the entire deck length and/or width, or it may be divided, having more than one screen and/or perforated metal sheet. A series of screens or perforated metal sheets may be arranged in a tiered or flat grouping with respect to each other. A grouping of screens and/or metal sheets may have different slopes. Regions of the deck that are not covered with a screen are closed off to flow of fluid therethrough. If a grouping of screens and/or metal sheets are used, they need not all be the same.

The screen assembly 20 may have more than one layer. In one embodiment it may form a single layer over which the fluid and cuttings will pass. In other embodiments the screen assembly may be in two or more layers on the chute, so that fluids and cuttings pass through an upper layer and drop to the surface of a layer below. In yet other embodiments the screen assembly is in two or more layers, and the tailings from the shaker are delivered to all layers of the screen assembly concurrently, and they operate in parallel.

The open-air area of the perforations or screen mesh can range between 1% and 99% of the area of the deck, between 10% and 90% of the area of the deck, or between 20% and 80% of the area of the deck. The area of the deck that is covered with a screen or perforated metal sheet may be substantially larger than the area covered by a screen in a shale shaker, because the forceful vibration of the shaker limits the size of the screens that can be used. The size of the perforations will directly affect the fluid recovery capability of the chute.

It is anticipated that a perforated metal sheet will have a lower co-efficient of friction than a screen, and therefore that cuttings will be transported more quickly along a metal sheet than a screen, having equivalently-sized openings. The shape of the perforations in the metal plate may varied as needed, for example the openings may have a rectangular, circular, triangular or other shape, and/or they may have partially or fully raised or recessed edges, or they may be angled relative to the surface of the plate. The screen/perforated metal surface may be coated to reduce friction, for example with PTTFE.

In some embodiments of the chute an airflow discharge 30 may be located below the screen assembly, to blow air through the perforations or screen to dislodge any particulates that may become trapped therein. If multiple levels of screen assembly are used, airflow discharge “cleaning units” would preferably be located under each level.

The screen assembly may further comprise a manifold 24 fluidly connected thereto, to which ports for delivery of air, for application of a vacuum, and/or for collection of the drilling fluid that passes through the screen assembly.

### Vibrating Apparatus

When the transit of the tailings along the chute is too slow, for example when the deviation of the chute from horizontal is too slight, the transit of the cuttings along the screen assembly may be assisted by agitating the deck, and consequently the screen assembly, with a vibrating apparatus 28. The vibrating apparatus may be engaged on a demand basis, or may operate continuously. The deck is subjected to substantially lower force vibrations than is typically used for the basket of shale shakers, as fast conveyance is generally required in the shakers whereas the objective of the chute is to maximize fluid recovery and conveyance can be slower. In some embodiments the deck 18 of the chute will vibrate at about 10 Hz.

The vibrating apparatus 28 vibrates the deck and consequently the screen assembly 20 in a circular, elliptical (balanced or unbalanced) or linear manner. Linear vibration will maximize the volume of discharged fluids that is processed by the chute by decreasing conveyance time; an elliptical motion may be used to keep the cuttings on the screen assembly for longer, to allow greater drying and fluid recovery.

As compared to conventional shale shakers, the screen assembly in the fluid recovery chute described herein deviates to a greater degree from horizontal. The chute requires less energy to operate than a shale shaker because the greater angle from horizontal facilitates solids movement and also because vibration of the screens is minimal in comparison, if they are vibrated at all. In large operations, the footprint limits the size of the shale shakers. The fluid recovery chute described herein is operated downstream of shakers and can have a larger processing area than the shakers themselves, again maximizing the potential for drilling fluid recovery.

### Vacuum Assist

The use of a vacuum force can be highly effective for increasing the amount of drilling fluid obtained from the shaker tailings as they pass over the screen assembly 20. Thus, a pressure differential may be generated below the screen assembly using a vacuum system that is operatively connected below the screen assembly. A pressure differential may be induced on only a portion of the screen assembly, while normal gravity drainage employed in other areas, or it may be used on the entirety of the screen assembly.

The vacuum system may comprise a manifold 24 that is substantially sealed to the bottom of the screen assembly 20 or portion thereof, and vacuum lines fluidly communicating between the manifold and a vacuum pump. In embodiments of the chute using vibration to assist in particulate movement, the manifold vibrates with the deck and screen assembly. In preferred embodiments the manifold is configured closer to the discharge end of the chute than to the receiving end of the chute. If two or more manifolds 24 are used on a single chute 10, they may use a common vacuum pump.

The vacuum may be a non-conveying vacuum or a conveying vacuum. The vacuum force may be continuous or pulsed, drawing air and consequently drilling fluid through the screen assembly 20 or portion thereof. Pulsing of the vacuum, and dynamic control of the vacuum, may be accomplished for example as described in WO2014/161064. The pressure differential is preferably sufficiently large to promote removal of drilling fluid from the particulates but not so large as to stall the particulates, except perhaps momentarily, in a pulsed system.

The vacuum system located below screen assembly 20 may be independent of, or integral to, the fluid recovery process. In some embodiments therefore the vacuum may not only induce a pressure differential, but may also capture and transport the recovered fluid to a storage tank for reuse. Multiple layer systems would typically have a vacuum system located beneath the lowest level.

Having thus described the basic apparatus and method herein, specific embodiments will now be described, as shown in the accompanying Figures.

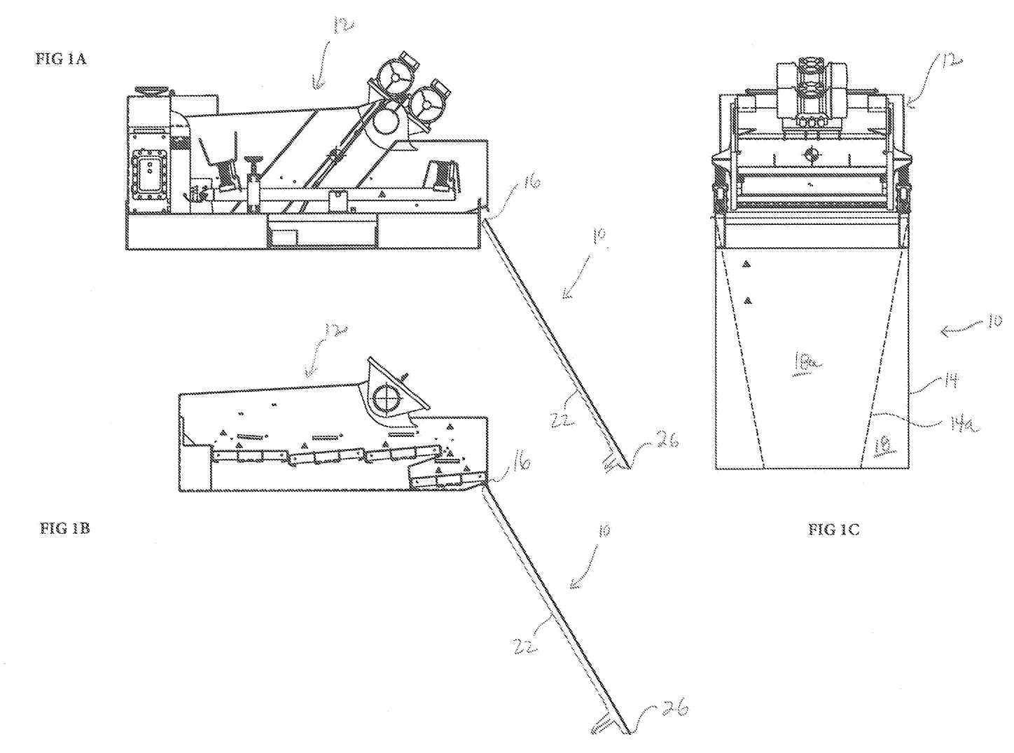

FIG. 1A is a side view of a shale shaker 12 with an embodiment of the recovery chute 10 attached thereto. FIG. 1B is a cross sectional view of the embodiment of FIG. 1A. FIG. 1C depicts a top view of the shale shaker 12 of FIG. 1A. The recovery chute 10 is shown with a deck support frame 14 and deck 18 depicted by the solid lines and a modified support frame 14a and deck 18a depicted by the dashed lines. Collection tray 22 is disposed underneath the screen assembly 20, and drilling fluid that flows through the screen assembly is collected in the tray and drained from the tray by drain connection port 32, which may or may not be connected to a conveying vacuum.

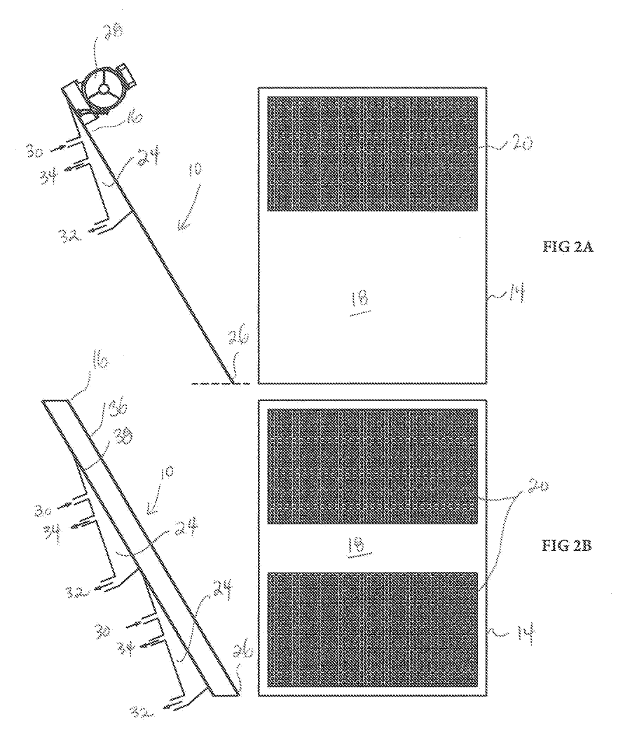

FIG. 2A (left) and (right) are a side view and a top view, respectively, of an embodiment of the recovery chute with a vibrating apparatus attached, showing air inflow port 30, a port 32 which functions as a drain connection and which may be connected to a conveying vacuum (“a drain/vacuum port”), and a port 34 for connecting to a non-conveying vacuum, extending from manifold 24. Some, or all, of these ports may be used at any one time. In this embodiment an upper part of the chute includes screen assembly 20, in fluid communication with the manifold underneath.

FIG. 2B (left) and (right) are side view and a top view, respectively, of an embodiment of the recovery chute in which the screen assembly 20 covers both the upper part and the lower part of the deck 18 of the chute. This embodiment further has two layers of screen assembly 20, a top layer 36 and a bottom layer 38. In the bottom layer, the screen assembly is associated with 2 manifolds 24, one for each part of the screen assembly, each manifold having ports 30, 32 and 34. Some, or all, of these ports may be used at any one time.

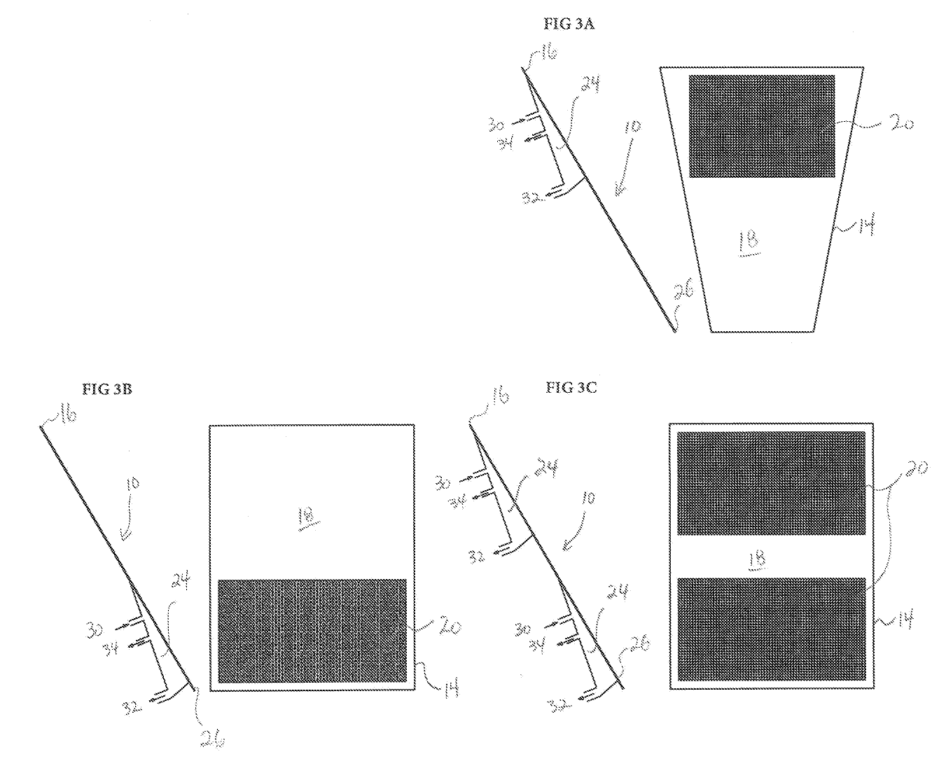

FIG. 3A (left) and (right) are a side view and a top view, respectively, of an embodiment of the recovery chute with a deck 18, which includes a screen assembly 20 on the upper part of the deck. Air inflow port 30, vacuum port 34 and drain/vacuum port 32 extend from manifold 24 sealably connected to the deck underneath the screen assembly. Some, or all, of these ports may be used at any one time.

FIG. 3B (left) and (right) are a side view and a top view, respectively, of an embodiment of the recovery chute in which includes a screen assembly 20 on the lower part of the deck. Air inflow port 30, vacuum port 34 and drain/vacuum port 32 extend from manifold 24 sealably connected to the deck underneath the screen assembly. Some, or all, of these ports may be used at any one time.

FIG. 3C (left) and (right) are side view and a top view, respectively, of an embodiment of the recovery chute in which includes a screen assembly 20 that covers both the upper part and the lower parts of the deck. Each portion of the screen assembly 20 is in fluid communication with a manifold 24 having an air inflow port 30, vacuum port 34 and drain/vacuum port 32. Some, or all, of these ports may be used at any one time.

Also provided herein is a method for screening tailings from a shale shaker, comprising attaching a chute as described herein to the discharge end of the shale shaker, introducing the tailings from the shale shaker onto the receiving end of the chute, whereupon drilling fluid within the tailings flows through the screen assembly into a collection tray or manifold, and larger particulates and drilling fluid that are unable to flow through the screen assembly move towards the discharge end of the chute. In some embodiments of the method the screen assembly is vibrated. In some embodiments of the method, air is introduced from below the screen assembly to dislodge particulates that may become trapped thereon. In some embodiments, a vacuum is used to assist with the flow of drilling fluid through the screen assembly.

1. A drilling fluid recovery chute for recovering drilling fluids from the tailings of a shale shaker comprising:
a) a chute support frame having a receiving end configured to receive the tailings directly or indirectly from the discharge end of a shale shaker;
b) a deck disposed on the chute support frame which receives the tailings from the shale shaker; and
c) a screen assembly disposed on the deck and configured to separate the drilling fluids from the tailings and deliver these drilling fluids to a collection tray or manifold disposed below the screen assembly.

2. A method of recovering drilling fluids from the tailings of a shale shaker comprising:
a) introducing the tailings from the shale shaker onto a fluid recovery chute that has a screen assembly disposed thereon to separate the drilling fluid in the tailings from larger particulates in the tailings;
b) collecting the separated drilling fluid; and
c) moving the larger particulates along the surface of the screen assembly towards a discharge end of the chute.
